(19) United States
(12) Patent Application Publication
(10) Pub. No.: US 2018/0091608 A1
(43) Pub. Date: Mar. 29, 2018

(54) DYNAMIC VEHICLE REQUEST STRATEGIES

(71) Applicant: General Motors LLC, Detroit, MI (US)

(72) Inventors: Esteban CAMACHO, Belleville, MI (US); Alexander CERMAK, Grosse Pointe Woods, MI (US); Ryan OLEJNICZAK, Clinton Township, MI (US); David A. ADAMS, Troy, MI (US)

(21) Appl. No.: 15/277,241

(22) Filed: Sep. 27, 2016

(51) Int. Cl. H04L 29/08

(52) U.S. Cl. CPC H04L 67/22; H04L 67/141; H04L 51/38; H04L 67/125; H04L 67/306

(57) ABSTRACT

A method and system for communicating with a vehicle, e.g., to send vehicle commands. The system is used to carry out the method which includes receiving a user login request establishing a current vehicle application session, and analyzing an application history of the user including usage data for at least one previous vehicle application session of the user. The method includes, based upon the analysis of the previous vehicle application session(s) of the user, limiting or prohibiting use of a packet data session for transmitting vehicle commands to a vehicle in response to the user login request. In other implementations, a previous vehicle application session of the user may be used to present a vehicle command sequence during the current vehicle application session to the user.

### TECHNICAL FIELD

The present invention relates to systems and methods for controlling vehicles via remote devices, and more particularly to systems and methods for executing vehicle commands via mobile communication devices such as smartphones.

### BACKGROUND

Remote controls for motor vehicles include systems relying on the use of vehicle-specific parts, e.g., key fobs, to lock, unlock, or even start the engine of a motor vehicle. More recently, original equipment manufacturers (OEMs) have equipped vehicles with systems that can be accessed and/or controlled remotely via a mobile device such as a smartphone or computer. For example, some vehicles now come equipped with systems that respond to user commands transmitted from a mobile device by way of an application supported on the mobile device. Vehicle users now may access and command an increasing number of vehicle systems. Merely by way of example, users may access vehicle information such as tire pressure, fuel level, oil level, recent fuel economy via these applications. Additionally, users now may send a variety of vehicle commands by way of these applications, such as unlocking/locking the vehicle, remotely starting the engine, or activating a horn or alarm of the vehicle.

At present, vehicle manufacturers and service providers use any of several different systems for communicating with user vehicles to send requested commands and obtain vehicle information. Merely as examples, a remote facility such as a central office or backoffice may communicate with a vehicle by way of short message service (SMS) text messages, or with packet-switched wireless data systems. The different systems have advantages and disadvantages for different types of communications with the vehicle. For example, an SMS message may be relatively quick for communicating with a vehicle to send a command. A packet-based wireless data system may be relatively cheaper in terms of cost per unit of data transmitted, but also typically requires more time for a remote facility to establish a link to a vehicle. Packet-based communication may also be inefficient in terms of using communication system resources where a user sends a limited number of commands. Given the different needs and habits of different users, the appropriate system is not always used for communicating commands and information to/from the vehicles.

Accordingly, there is a need for an improved remote command system and method for vehicles that addresses the above shortcomings.

### SUMMARY

In accordance with an aspect of the invention, there is provided a method of communicating with a vehicle. The method includes receiving a user login request establishing a current vehicle application session, and analyzing an application history of the user including usage data for at least one previous vehicle application session of the user. The method further includes selectively initiating a packet data session for transmitting vehicle commands with a vehicle in response to the user login request based upon the previous vehicle application session(s) of the user.

In accordance with another aspect of the invention, there is provided a method of communicating with a vehicle that includes receiving a user login request establishing a current vehicle application session, and analyzing an application history of the user including usage data for at least one previous vehicle application session of the user. The method may further include selectively limiting initiation of a packet data session for transmitting vehicle commands with a vehicle in response to the user login request based upon the at least one previous vehicle application session of the user.

In yet another aspect of the invention, there is provided a method that includes receiving a user login request establishing a current vehicle application session, and analyzing an application history of the user including usage data for at least one previous vehicle application session of the user. The method further includes presenting a vehicle command sequence during the current vehicle application session based upon the at least one previous vehicle application session of the user.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the exemplary methods disclosed herein; and

FIG. 2 is a process flow diagram illustrating exemplary methods of communicating with a vehicle.

### DETAILED DESCRIPTION OF THE ILLUSTRATED EMBODIMENT(S)

Exemplary illustrations are described herein of a vehicle and associated methods of communicating with a vehicle, e.g., to send vehicle commands and obtain vehicle information. The disclosed exemplary approaches generally allow for a user history to be analyzed to facilitate a more efficient use of available systems for sending commands to the vehicle.

### Communications System

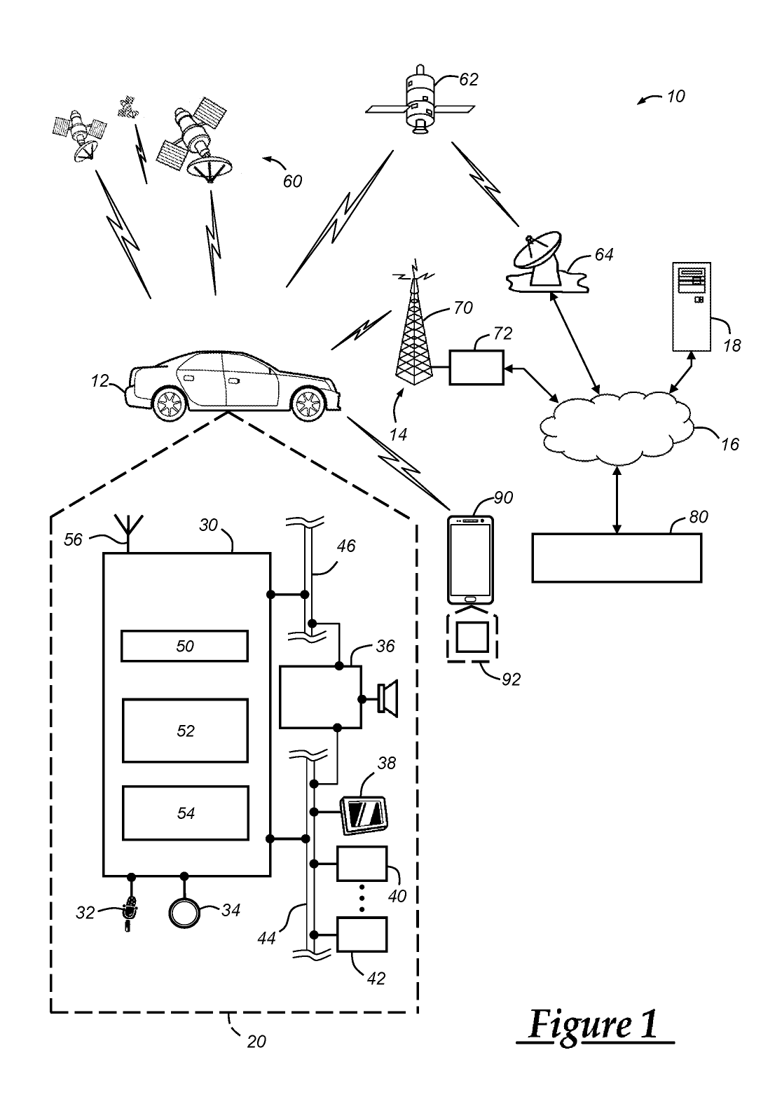

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, a remote facility 80, and a mobile device 90. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and include a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with remote facility 80, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art, or via other wireless communication methods, e.g., SMS/text messages. For combined services that involve both voice communication (e.g., with a live advisor or voice response unit at the remote facility 80) and data communication (e.g., to provide GPS location data or vehicle diagnostic data to the remote facility 80), the system can utilize a single call over a voice channel and switch as needed between voice and data transmission over the voice channel, and this can be done using techniques known to those skilled in the art.

According to one embodiment, telematics unit 30 utilizes cellular communication according to GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 18, for other purposes, such as fleet management. Also, new or updated map data can be downloaded to the GPS module 40 from the remote facility 80 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 20 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the remote facility 80. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to remote facility 80. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 80, or both. A computer 18 can also be used for providing Internet connectivity such as DNS services or as a network address server that uses DHCP or other suitable protocol to assign an IP address to the vehicle 12.

Remote facility 80 is designed to provide the vehicle electronics 20 with a number of different system back-end functions. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 16. A database at the remote facility can store account information such as subscriber authentication information, vehicle identifiers, profile records, behavioral patterns, and other pertinent subscriber information. Data transmissions may also be conducted by wireless systems, such as 882.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used.

Mobile device 90 is a non-vehicle device, meaning that it is not a part of vehicle 12 or vehicle electronics 20. The mobile device includes: hardware, software, and/or firmware enabling cellular telecommunications and/or short range wireless communication (SRWC), as well as other wireless device functions and applications. The hardware of mobile device 90 comprises a processor and memory for storing the software, firmware, etc. This memory may include volatile RAM or other temporary powered memory, as well as a non-transitory computer readable medium that stores some or all of the software needed to carry out the various external device functions discussed herein. The mobile device processor and software stored in the memory enable various software applications, which may be preinstalled or installed by the user (or manufacturer) (e.g., having a software application or graphical user interface (GUI)). This may include an application 92 that can allow a vehicle user to communicate with vehicle 12 and/or to control various aspects or functions of the vehicle—e.g., among other things, allowing the user to remotely lock/unlock vehicle doors, turn the vehicle ignition on or off, check the vehicle tire pressures, fuel level, oil life, etc. The application may also be used to enable the user of device 90 to view information pertaining to the vehicle (e.g., the current location of the vehicle, whether the vehicle is locked or unlocked) and/or pertaining to an account associated with the user or vehicle. Wireless device 90 is shown as a smartphone having cellular telephone capabilities. In other embodiments, device 90 may be a tablet, laptop computer, or any other suitable device. In addition, application 92 may also allow the user to connect with the remote facility 80 or call center advisors at any time.

Accordingly, mobile device 90 may generally be used to send commands to the vehicle 12 via different communication paths and/or systems. Available communication paths may have relative advantages and disadvantages which depend on the manner in which the user interacts with the system to send commands or obtain information, which as further discussed below may be used to determine how each path is employed to best provide service to a user of the vehicle 12. Merely as one example, in an exemplary communication system both an SMS message system and a packed-switched data system may be used in concert to communicate with the vehicle 12 and send commands to the vehicle 12.

A packet-switched wireless communication system may generally be preferable for communicating or sending commands to a vehicle, however there is often a short delay in communicating with the vehicle. More specifically, packet communication systems may have a short delay while a vehicle “wakes up” and establishes a connection with a remote facility from which the vehicle commands are transmitted. The “wake up” of the vehicle 12 may be initiated by another type of communication, e.g., an SMS message sent to the vehicle 12 at the behest of the remote facility 80. As a result, remote facility 80 may attempt to establish a packet-based communication link with the vehicle 12 in anticipation of a user sending commands, e.g., immediately upon a user logging in to the remote application 92, or any other indication that the user may be preparing to send a vehicle command. However, as packet communication systems may have limited bandwidth that must be allocated amongst a large number of vehicles, it may be less desirable to use a packet communication method when other communication methods will suffice. Merely as one example, an SMS message may typically be sent very quickly to a vehicle. SMS messages, however, may be relatively more costly if used extensively for transmitting vehicle commands, and thus in many situations a packet-based communication method may be preferred.

Typically, once a user becomes familiar with using the system, e.g., by accessing information and entering commands by way of the application 92 on mobile device 90, the user sends vehicle action requests in a similar pattern. For example, some users may often send a similar group or sequence of commands. Merely by way of example, a user may often send the vehicle 12 a command to remotely start the vehicle 12, followed immediately by a command to unlock the door(s) of the vehicle 12 as they are preparing to travel in vehicle 12. Other users may access the mobile application 92 frequently to access vehicle information without sending any commands to the vehicle 12. In still another pattern example, a user may browse vehicle information in the application 92 for some time, before sending one or more vehicle commands. Alternatively, some users may tend to log in to the application 92 solely for the purpose of sending a vehicle command almost immediately after logging in.

In the exemplary illustrations herein, discernible patterns in a user's history may be used to modify how available communication systems are used for sending future commands. Merely as examples, remote facility 80 may review the login history of a user via application 92, any commands sent by the user, timing for doing so, and the particular commands sent, if applicable in order to establish a more efficient method of using available communication paths for future logins of the user to the application 92. Application of specific rules will depend on the relative advantages and disadvantages of available systems for sending commands to vehicles, and thus different rules may be employed consistent with maximizing efficient use of communication resources in dependence upon the relative advantages and disadvantages.

Accordingly, the exemplary illustrations herein may facilitate use of a packet-based communication system and SMS system together to efficiently communicate with or send commands to a vehicle in a manner that minimizes delays in commands and use of system resources. Generally, packet-based communication sessions may be more cost and resource effective than SMS systems on a per-communication basis. Thus, packet-based communications may be cheaper in terms of cost and system resource usage where multiple commands are sent by a user. On the other hand, where a user does not typically use the mobile application to send commands to the vehicle, or tends to send only one or a few commands, it may not make sense to use packet-based communication system resources each time the user logs in. Additionally, where a user is in the habit of sending commands, but only after browsing vehicle data in the application on their mobile device, i.e., after the vehicle can typically establish a packet-based data connection to a remote facility forwarding the commands, a packet-based communication may be more efficient than alternative communications such as SMS messages. Accordingly, in such situations it may be desirable to initiate a packet-based communication link with the vehicle when there is some indication that the user is about to send a command, e.g., the user logs in to the mobile device application.

### Method

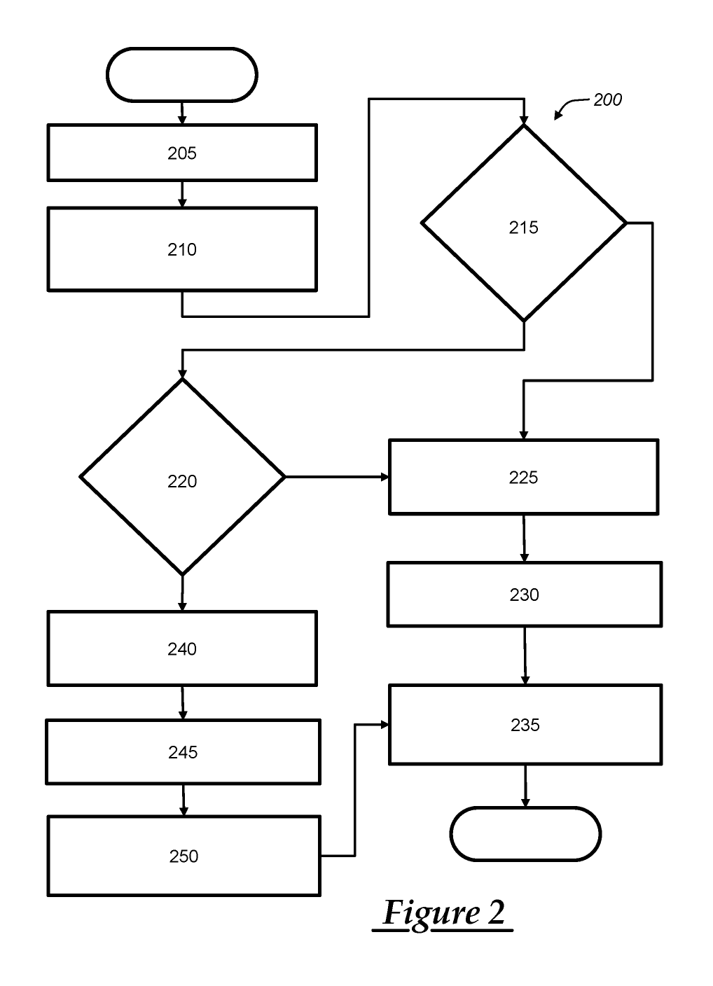

Turning now to FIG. 2, a process flow diagram illustrating various exemplary methods of communicating with a vehicle is shown. Process 200 may begin at block 205, where user data from previous communications with a vehicle 12 is retrieved. In situations where a user has a history of using the application 92 and/or sending commands to the vehicle 12, the history may be reviewed for any pattern(s) that may be used to more efficiently use available communication systems/paths. In some examples, remote facility 80 may review records associated with one or more users, identifying user-specific, group-specific, or universal rules to be applied regarding how available communication systems/paths are used.

Proceeding to block 210, an indication that a user may be about to send command(s) to the vehicle 12 may be received, e.g., at remote facility 80. For example, one example of such indication may be a user logging in to application 92. The user logging in to the application by entering security information such as a password, personal identification number, fingerprint, or the like may provide an indication that the user may be preparing to send command(s) to the vehicle 12. Process 200 may then proceed to block 215.

At block 215, process 200 may query whether the user has a history of sending any vehicle commands after logging in to the application 92. If the user has a history of sending commands to vehicle 12, process 200 may proceed to block 220. On the other hand, if the user's history indicates that the user typically or always logs in to the application 92 but does not send commands to the vehicle, process 200 proceeds to block 225.

If there is little or no command history of the user as determined in block 215, the remote facility 80 may limit or prevent entirely use of a packet data session with vehicle 12 at block 225. In some examples, an activity timer associated with a packet data session is reduced, thereby reducing usage of the packet data session unless being actively used by the user. Alternatively, a packet data session may be prohibited entirely for the current login activity by the user.

Proceeding to block 230, if a command is ultimately sent to the vehicle 12, the command may be sent via SMS message assuming the packet data session is not available due to being limited or prohibited at block 225. Process 200 may then proceed to block 235, where a history of the user is updated with any activity from the current login/command session. Accordingly, if the user begins to behave differently with respect to the application 92, e.g., by sending commands more frequently, such changes may be recognized by remote facility 80 so that the available communication systems may be used in a different manner consistent with those changes during future activity by the user.

At block 220, upon a determination at block 215 that the user has a history of sending commands to the vehicle 12, process 200 queries whether a packet data session is justified. This determination may be made in any manner that is convenient. For example, process 200 may receive as inputs any relevant costs, resource usages, etc. associated with the available communication systems. As one example, sending commands via a packet-based communication link instead of via SMS message(s) may make sense from a cost and resource usage perspective only when more than one command, or more than some other predetermined number of commands, are sent. Since establishing a packet-based session with vehicle 12 may take some small amount of time, it may generally make sense to request initiation of a packet-based session only where there is some likelihood that multiple commands will actually be requested by the user once the connection is able to be established.

Accordingly, as part of block 220, process 200 may generally analyze whether the user has a history of sending multiple commands once a packet-data session has been established. Accordingly, if a user tends to send commands very quickly, i.e., before a packet data session can be established (and thus forcing the command to be sent via another path, e.g., SMS message), or tends to only send one command or very few commands after the packet data session is established, process 200 may determine that a packet-data session is not justified. Process 200 may therefore use as an additional input for analysis any relevant time limits or periods required to establish a packet-based data connection with vehicle 12. For example, if establishing a packet data session with vehicle typically requires five seconds, process 200 may determine whether multiple commands tend to be sent by the user five seconds after they log in to application 92. If process 200 determines that a packet data session is justified or expedient, process 200 may proceed to block 240. If, on the other hand, process 200 determines that establishing a packet data session with the vehicle 12 would use more network resources than appropriate, process 200 may proceed to block 225.

If requesting a packet data session with the vehicle 12 is not justified or should be limited as determined in block 220, process 200 may proceed to block 225. As described above, at block 225, process 200 generally limits use of or prevents initiation of a packet data session with the vehicle 12 to avoid using packet data system resources or bandwidth. As described above, at blocks 230 and 235 commands to the vehicle 12 may be sent via SMS message assuming the packet data session is not available, and updates any relevant user history to capture any changes in user behavior.

If process 200 determines at block 220 that a packet data session with the vehicle is justified or otherwise should not be restricted, process 200 proceeds to block 240, where a packet data session is requested. For example, remote facility 80 may send a communication to the vehicle 12, e.g., by way of SMS message, requesting that the vehicle 12 initiate a packet data session. The vehicle 12 may then establish a packet-data session, thereby allowing any commands to be sent to the vehicle by way of the packet data system.

Proceeding to block 245, a command list or menu may be displayed or offered to the user. For example, if a user has a history of sending a number of commands when logging in to application 92, the sequence may be offered to the user to confirm sending each of those commands. Accordingly, the user is not required to go through the steps of entering each command or re-enter security information, e.g., a password or PIN, in order to send the same commands they typically send upon logging in.

Merely by way of example, one exemplary command sequence may be a remote start command, followed immediately by a driver door unlock command, followed immediately by a passenger door unlock command. A user may send such a command sequence when preparing to use vehicle 12, and wishes to have the interior warmed/cooled to reduce extreme temperature present in the vehicle 12 and vehicle unlocked so they may simply enter the vehicle and depart. Accordingly, at block 245, upon seeing this command sequence used routinely in the user's history, or seeing or more steps completed in the typical sequence, remote facility 80 may transmit this menu of commands to the user offering a yes/no confirmation to the user that the command sequence should be sent to the vehicle 12.

Proceeding to block 250, vehicle command(s) may be sent to the vehicle 12 via the packet data session initiated at block 240, assuming availability. For example, once the packet data connection is available, any and all commands may be sent via this communication path. If the packet data connection is not available, e.g., due to loss of transmission, inactivity of the user beyond a predetermined limit, or the like, alternative communication paths may be used, such as an SMS/text message.

Process 200 may then proceed to block 235 where, as noted above, the user history may be updated with activity information from the current application session. Accordingly, as noted above, when the user history is retrieved in a future login session, e.g., at block 205, available communication systems are deployed in a manner consistent with any changes over time remains consistent with collective history of the particular user.

Process 200 may allow efficient utilization of available communication paths for multiple users. Accordingly, usage data for multiple users or groups thereof may be analyzed, and different behaviors of the system provided for each, so that future application sessions are matched to each user's particular habits.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of communicating with a vehicle, comprising the steps of:
(a) receiving a user login request establishing a current vehicle application session;
(b) analyzing an application history of the user including usage data for at least one previous vehicle application session of the user; and
(c) selectively initiating a packet data session for transmitting vehicle commands with a vehicle in response to the user login request based upon the at least one previous vehicle application session of the user.

2. The method of claim 1, further comprising preventing initiation of a packet data session in step (c) when at least one of a cost and a resource usage associated with transmitting the vehicle commands via the packet data session exceeds that of an alternative vehicle communication type.

3. The method of claim 2, wherein the alternative vehicle communication type is a short message service (SMS) message.

4. The method of claim 1, further comprising preventing initiation of a packet data session in step (c) when the at least one previous vehicle application session of the user indicates a lack of user commands sent in the at least one previous vehicle application session.

5. The method of claim 1, further comprising preventing initiation of a packet data session in step (c) when the at least one previous vehicle application session of the user indicates user commands during the at least one previous vehicle application session, the user commands sent before expiration of a predetermined time limit following initiation of the at least one previous vehicle application session.

6. The method of claim 1, further comprising initiating a packet data session in step (c) when the at least one previous vehicle application session of the user indicates user commands sent during the at least one previous vehicle application session, the commands sent after expiration of a predetermined time period following initiation of the at least one previous vehicle application session.

7. The method of claim 6, wherein the predetermined time period is determined from an initialization time of the packet data session.

8. The method of claim 7, wherein the predetermined time period is substantially equal to the initialization time of the packet data session.

9. The method of claim 1, further comprising presenting a vehicle command sequence during the current vehicle application session, the vehicle command sequence based upon the at least one previous vehicle application session of the user.

10. The method of claim 9, further comprising determining a pattern of vehicle commands in the at least one previous vehicle application session of the user, wherein the vehicle command sequence matches the determined pattern.

11. The method of claim 1, further comprising receiving user login requests from a plurality of users, and selectively initiating packet data sessions for transmitting vehicle commands to their respective vehicles in response to each of the user login requests based upon at least one previous vehicle application session of each user.

12. The method of claim 1, further comprising selecting a communication path for transmitting vehicle commands to a vehicle in response to requests received from the user during the current vehicle application session, wherein the communication path is selected from two available communication paths based upon the application history of the user.

13. The method of claim 1, further comprising transmitting at least one vehicle command to the vehicle via a short message service (SMS) message.

14. The method of claim 1, wherein the vehicle commands include wherein the vehicle action requests include one of a remote start request, an unlock request, a lock request, and an alarm request.

15. A method of communicating with a vehicle, comprising the steps of:
(a) receiving a user login request establishing a current vehicle application session;
(b) analyzing an application history of the user including usage data for at least one previous vehicle application session of the user; and
(c) selectively limiting initiation of a packet data session for transmitting vehicle commands with a vehicle in response to the user login request based upon the at least one previous vehicle application session of the user.

16. The method of claim 15, further comprising preventing initiation of a packet data session in step (c) when at least one of a cost and a resource usage associated with transmitting the vehicle commands via the packet data session exceeds that of a short message service (SMS) message.

17. The method of claim 15, further comprising preventing initiation of a packet data session in step (c) when the at least one previous vehicle application session of the user indicates a lack of user commands sent in the at least one previous vehicle application session.

18. The method of claim 15, further comprising preventing initiation of a packet data session in step (c) when the at least one previous vehicle application session of the user indicates user commands during the at least one previous vehicle application session, the user commands sent before expiration of a predetermined time limit following initiation of the at least one previous vehicle application session.

19. The method of claim 15, further comprising initiating a packet data session in step (c) when the at least one previous vehicle application session of the user indicates user commands sent during the at least one previous vehicle application session, the commands sent after expiration of a predetermined time period following initiation of the at least one previous vehicle application session.

20. A method of communicating with a vehicle, comprising the steps of:
(a) receiving a user login request establishing a current vehicle application session;
(b) analyzing an application history of the user including usage data for at least one previous vehicle application session of the user; and
(c) presenting a vehicle command sequence during the current vehicle application session based upon the at least one previous vehicle application session of the user.
